(19) United States
(12) Patent Application Publication
(10) Pub. No.: US 2024/0340942 A1
(43) Pub. Date: Oct. 10, 2024

(54) SIDELINK SIGNAL SENSING OF PASSIVELY REFLECTED SIGNAL TO PREDICT DECREASE IN RADIO NETWORK PERFORMANCE OF A USER NODE-NETWORK NODE RADIO LINK

(71) Applicant: Nokia Technologies Oy, Espoo (FI)

(72) Inventors: Mikko SÄILY, Espoo (FI); Stephan SIGG, Espoo (FI); Sameera PALIPANA, Espoo (FI); Si-Ahmed NAAS, Espoo (FI)

(21) Appl. No.: 18/579,462

(22) PCT Filed: May 5, 2022
(86) PCT No.: PCT/EP2022/062095

§ 371 Date: Jan. 15, 2024

(30) Foreign Application Priority Data
Jul. 15, 2021 (FI) 20215809

(51) Int. Cl. H04W 72/542; H04W 72/40

(52) U.S. Cl. CPC H04W 72/542; H04W 72/40

(57) ABSTRACT

A method includes controlling receiving channel information for a sidelink channel between a first user node and a second user node, wherein the channel information is determined by the second user node based on the sidelink reference signal transmitted by the first user node that has been at least partially passively reflected format least one object within a physical environment; determining that there is a predicted decrease in a radio network performance for a radio link between the first user node and a network node; and controlling transmitting, by the first user node to a network node, information indicating that there is a predicted decrease in radio network performance for the radio link between the first user node and the network node, to enable the network node to perform a corrective action based on the predicted decrease in radio network performance.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include: determining, by a user node, sidelink resources of a sidelink channel for transmission of a sidelink signal for sensing; controlling transmitting, by the user node, the sidelink signal using the sidelink resources of the sidelink channel; determining, by the user node, channel information for the sidelink channel, wherein the channel information is based on the transmitted sidelink signal that has been at least partially passively reflected from at least one object within a physical environment; determining, by the user node based at least on the channel information for the sidelink channel and a model, that there is a predicted decrease in a radio network performance for a radio link between the user node and a network node; and controlling transmitting, by the first user node to the network node, information indicating that there is a predicted decrease in radio network performance for the radio link between the first user node and the network node, to enable the network node to perform a corrective action based on the predicted decrease in radio network performance.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a user node (or UE).

FIG. 3 is a diagram further illustrating the method of FIG. 2.

FIG. 4 is a diagram illustrating a system that includes user nodes or UEs and a gNB/network node in which UE1 both transmits a sidelink signal and receives the reflected sidelink signal to measure channel information for the received signal.

FIG. 5 is a diagram illustrating an example of a FMCW radar signal.

FIG. 6 is a diagram illustrating operation of a system, including UE1, in which the UE1 both transmits a SL signal, and measures channel information on the at least partially passively reflected SL signal that is received by UE1.

FIG. 7 is a diagram illustrating a system that includes UEs and a gNB/network node in which UE1 transmits a SL signal, and UE2 measures channel information of the SL channel based on the at least partially passively reflected SL signal.

FIG. 8 is a diagram illustrating operation of the system according to FIG. 7.

FIG. 9 is a diagram illustrating an example of UE1 training a neural network model using supervised training.

FIG. 10 is a diagram illustrating an example of UE1 using a neural network model to predict a decrease in radio network performance of a UE1-gNB radio link.

FIG. 11 is a block diagram of a wireless station or node (e.g., network node, user node, or other node).

### DETAILED DESCRIPTION

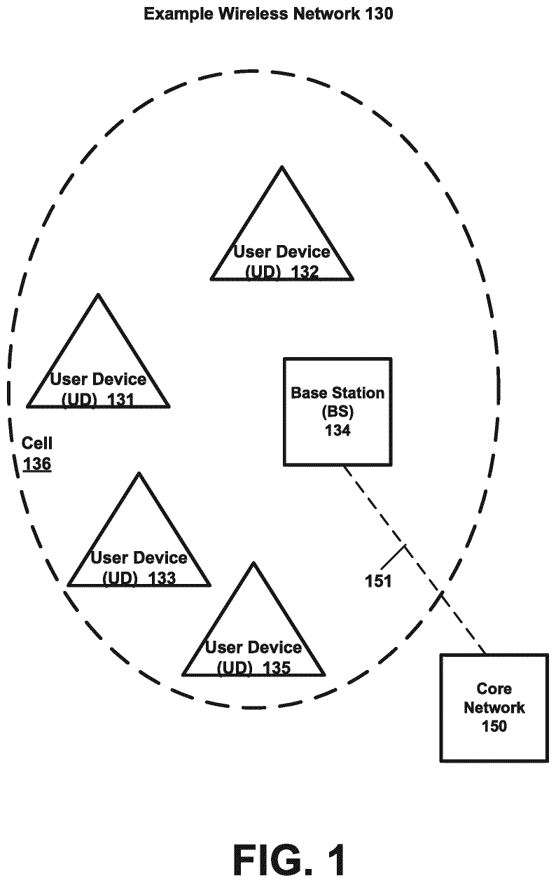

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e)Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, IoT, MTC, eMTC, eMBB, URLLC, etc., or any other wireless network or wireless technology. These example networks, technologies or data service types are provided only as illustrative examples.

As noted, 5G technologies are expected to significantly increase data rates (or bandwidths) and/or decrease latency. Many of the 5G technologies, such as URLLC, may require very strict performance, such as guaranteed low latency. However, the dynamic nature of a physical environment may cause radio network performance to frequently or continuously change. In some cases, environmental changes, e.g., various objects within the physical environment that may block or reflect signals, may cause radio network performance to degrade to a level that does not meet required 5G performance requirements for some 5G applications (e.g., URLLC applications), such as requirements for block error rate (BLER) or latency, as noted above. A UE or BS may measure a change in one or more radio network performance parameters, such as a change in signal-to-interference plus noise ratio (SINR), received signal strength or reference signal received power (RSRP), block error rate (BLER), or other measurement, e.g., indicating a degrading radio network performance of a UE-gNB radio link (the link or radio/wireless channel between the UE and gNB). However, due to very strict 5G network performance requirements (e.g., for latency and/or BLER or other requirements), in many cases, there may not be sufficient time for a UE or BS to detect a degrading radio network performance of a UE-gNB link, and then take an action to improve radio network performance before the performance of the radio network or wireless channel drops below an acceptable level for some 5G application(s).

Sidelink (SL) communications (which may also be referred to as device-to-device communications) are communications directly between UEs (or directly between user devices), e.g., without necessarily using or going through a network node (gNB or BS). A UE may obtain SL resources for a SL channel, to perform SL communications with one or more other nearby UEs. A UE may be involved in both traditional UE-gNB communications, and SL communications. Thus, a UE may have, for example, a UE-gNB radio link established for communication with a gNB or network node, and the UE may be part of SL group in which the UE may transmit and/or receive signals or information via SL resources of a SL channel with other member UEs of the SL group.

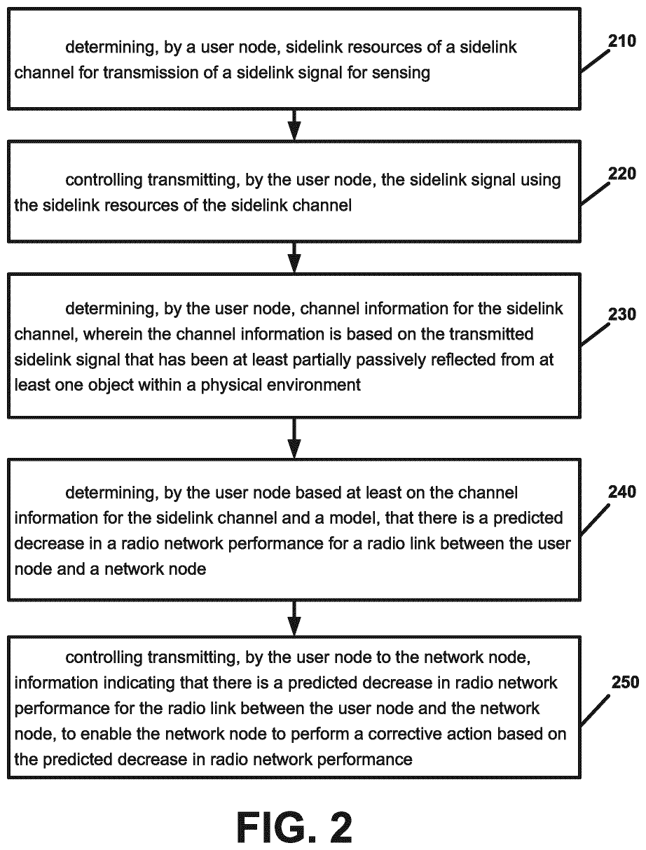

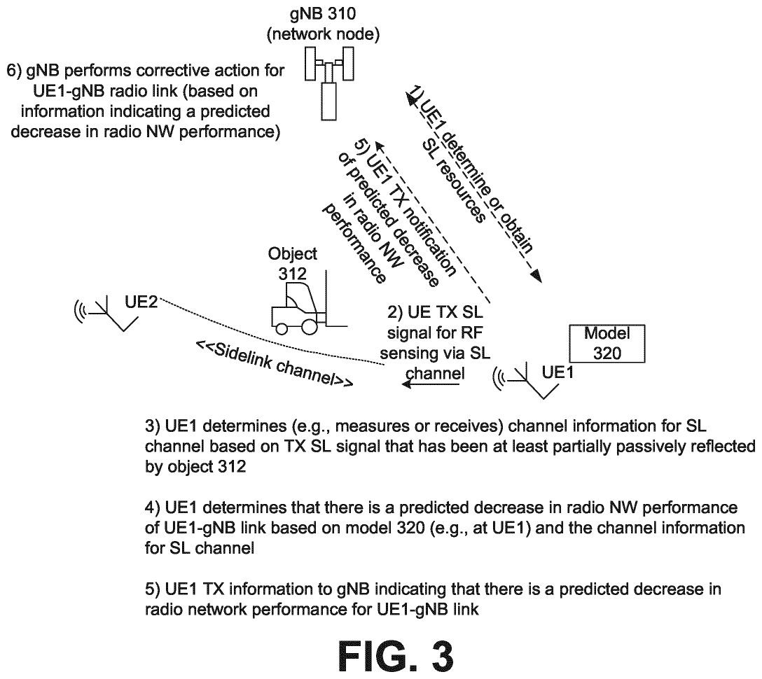

FIG. 2 is a flow chart illustrating operation of a user node (e.g., UE) according to an example embodiment. FIG. 3 is a diagram further illustrating the method of FIG. 2. UEs are illustrated herein as examples of user nodes, but other types of user nodes may be used as well. In FIG. 3, a UE1 may be in communication with UE2 via sidelink (SL) channel. UE1 may also have a UE1-gNB radio link established with gNB 310. An object 312 may be within a physical environment, e.g., and may be present and/or moving between UE1 and UE2, and/or may also be present and/or moving between UE1 and gNB 310. UE1 may have a model 320, e.g., such as a neural network model, which may be trained based on channel information of the SL channel associated with (e.g., occurring within a time window, or within a threshold period of time before) radio network performance information for the UE-gNB radio link.

For the method of FIG. 2, operation 210 includes determining, by a user node (or UE), sidelink resources of a sidelink channel for transmission of a sidelink signal for sensing. For example, at operation 1) of FIG. 3, UE1 may determine SL resources or may obtain obtain SL resources from gNB 310. Operation 220 of FIG. 2 includes controlling transmitting, by the user node, the sidelink signal using the sidelink resources of the sidelink channel. For example, at operation 2) of FIG. 3, UE1 may transmit a SL signal (e.g., a reference signal, a Frequency-Modulated Continuous Wave radar signal, or a chirp spread spectrum signal (CSS) or other signal) for sensing via SL resources of the SL channel. Operation 230 of FIG. 2 includes determining, by the user node, channel information for the sidelink channel, wherein the channel information is based on the transmitted sidelink signal that has been at least partially passively reflected from at least one object within a physical environment. For example, at operation 3) of FIG. 3, UE1 determines (e.g., measures, or receives from UE2) channel information for the SL channel based on the transmitted SL signal that has been at least partially passively reflected by object 312. For example, the UE1 may itself measure channel information for the SL channel based on an at least partially reflected signal (e.g., reflected back to UE1), and/or UE1 may receive channel information from UE2 that was measured by UE2 based on the transmitted SL signal that was at least partially passively reflected off of (or by) object 312. Operation 240 of FIG. 2 includes determining, by the user node based at least on the channel information for the sidelink channel and a model (e.g., such as a neural network model), that there is a predicted decrease in a radio network performance for a radio link between the user node and a network node. For example, at operation 4) of FIG. 3, the UE1 may determine that there is a predicted decrease in radio network performance of the UE1-gNB radio link based on the channel information of the SL channel and the model 320. Operation 250 includes controlling transmitting, by the user node to the network node, information indicating that there is a predicted decrease in radio network performance for the radio link between the user node and the network node, to enable the network node to perform a corrective action based on the predicted decrease in radio network performance. For example, at operation 5) of FIG. 3, UE1 may transmit information (e.g., a flag or bit indicating that there is a predicted decrease of RSRP (or other radio network performance parameter) of UE1-gNB radio link within the next time period (e.g., 400 ms), or more detailed information indicating a radio network performance parameter, e.g., SINR or RSRP, and a predicted value or predicted level of change or decrease of this radio network performance parameter, e.g., a predicted 20% decrease in RSRP or SINR within next 200 ms for UE1-gNB radio link.

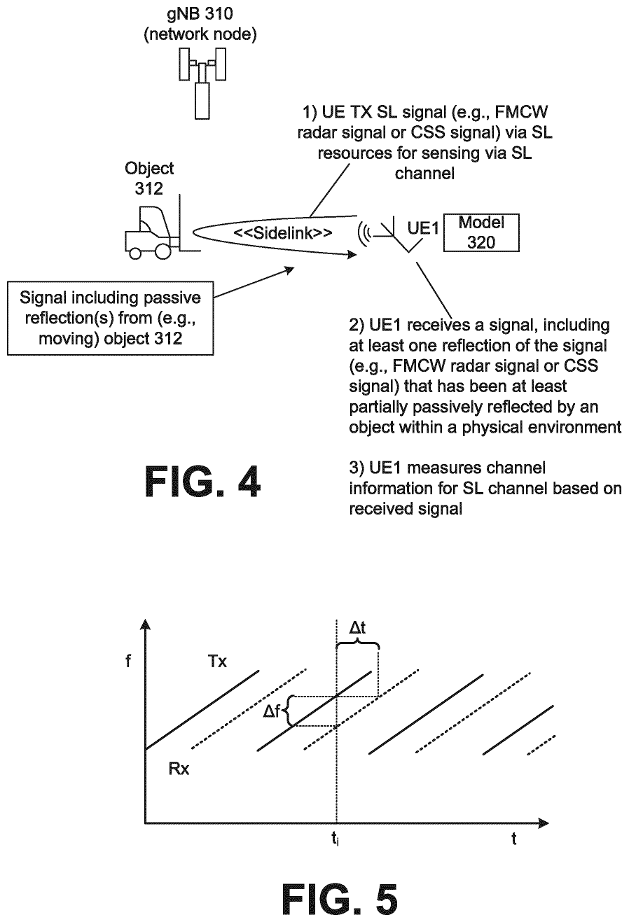

Further details, features, operations and/or examples are described below for or with respect to the method of FIG. 2. Also, FIGS. 4-10 illustrate further details, features, and/or operations with respect to the method of FIG. 2.

In at least some cases, an object(s) (or changes in physical environment) (e.g., blocking object that may block or reflect wireless signals) may cause changes for a sidelink channel (e.g., changes in channel information and/or changes in link performance of a SL channel for a UE) before the object(s) (or changes in physical environment) cause changes in a radio network performance parameter(s) (e.g., channel information or parameters indicating a radio link performance) for a UE-GNB radio link. This may be due to one or more objects that are moving near the UE and which may sometimes impact the radio network performance of both the SL channel for the UE and the UE-gNB link for the UE. As noted, in some situations, the object(s) may impact the performance of the SL channel before the object(s) impact performance of the UE-gNB radio link. Or, in some cases, a threshold change in (one or more parameters of) the SL channel may be detectable by the UE before (or maybe just before) the UE or gNB can detect a significant change in (one or more parameters of) the UE-gNB radio link due to the same object(s) or changes in the physical environment. Thus, at least in some cases, such detected changes (e.g., based on channel information for the SL channel) for a SL channel of a UE may be used as an early indication of expected changes (e.g., early indication of expected or predicted decrease in radio network performance) in a UE-gNB radio link for the same UE.

A model, e.g., such as a neural network model, may be used to map channel information for the SL channel to associated delayed (or future) changes or decreases in a radio network performance of a UE-gNB link (e.g., where the model may map channel information of a SL channel to future values or decreases in performance of a UE-gNB link that occur within a future time period, or that occur within a time window or time threshold of measuring or receiving the channel information of the SL channel). Therefore, in this manner, a more predictive and/or a more preemptive approach may be used to address an expected or predicted change or decrease in radio network performance of UE-gNB link based on channel information for a SL channel for the UE. A key benefit or technical advantage of such approach is that it enables execution or performing of preemptive corrective actions by the UE and/or network before the network performance (between the UE and gNB/network) has degraded or dropped below an acceptable level for critical application(s), such as URLLC.

As described in the flow chart of FIG. 2, a user node (e.g., UE or user device or other user node) may transmit a SL signal via SL resources of a SL channel. The UE may determine (e.g., measure itself, and/or receive SL signal measurements from another UE(s)) of channel information for the SL channel based on the transmitted SL signal that has been at least partially passively reflected by at least one object within a physical environment. Passively reflected (or passive reflection of a wireless signal) may refer to or may include an object that does not actively reflect a received signal, e.g., where the object does not actively transmit a signal. For example, passive reflection may include the object reflecting the wireless signal without electronic transmission or retransmission, e.g., the object does not use an electronic transceiver to receive and then transmit the SL signal. The UE (which transmitted the SL signal) may determine that there is a predicted decrease in a radio network performance for a UE-gNB radio link of the UE, based on the channel information of the SL channel. The UE may then transmit to the gNB information indicating that there is a predicted decrease in radio network performance of the UE-gNB link, e.g., to enable the gNB to perform a corrective action. In this manner, channel information, which has been measured by the transmitting UE (which transmits the SL signal) or measured by one or more other UEs and sent back to the transmitting UE, may be used to predict or estimate (that there will be or there is expected to be) a decrease in a radio network performance of a UE-gNB link, e.g., to enable the gNB to perform a corrective action for the UE. Further details are described hereinbelow.

For the method of FIG. 2, the model may be or may include a neural network model. Also, the predicted decrease in radio network performance may be predicted to occur within a time threshold of receiving the channel information, based on the neural network model.

Also, for the method of FIG. 2, the determining, by the user node, sidelink resources for transmission of a sidelink reference signal for sensing may include the user node performing at least one of: selecting the sidelink resources for transmission of the sidelink reference signal for sensing; or obtaining the sidelink resources from the network node based on the following: controlling transmitting, by the user node to the network node, a request for sidelink resources for transmission of a sidelink reference signal for sensing; and controlling receiving, by the user node from the network node, information indicating the sidelink resources for transmitting the sidelink reference signal for sensing.

For the method of FIG. 2, the channel information may include at least one of: 1) value of a channel-related parameter; 2) a processed channel-related parameter; and/or 3) a change (or a pattern of change) of at least one channel-related parameter. For example, the channel information may be or may include at least one of the following: a value of at least one channel-related parameter, including a value of at least one of: an amplitude, a received power, a reference signal received power (RSRP), or a received signal strength of the sidelink reference signal; a phase of the sidelink reference signal; a doppler shift at one or more antenna ports; a channel state information (CSI), including one or more of a channel quality indicator (CQI), a rank indicator (RI), CSI-RS resource indicator (CRI), SS/PBCH resource block indicator (SSBRI), Layer Indicator (LI) or a precoder matrix indicator (PI); a processed channel-related parameter, including at least one of: a mean, median, or variance of a plurality of values of a channel-related parameter; a change in at least one channel-related parameter, including a change or a pattern of changes of at least one of: an amplitude, a received power, a reference signal received power (RSRP), or a received signal strength of the sidelink reference signal; a phase of the received reference signal; a doppler shift at one or more antenna ports; a channel state information (CSI), including a change or a pattern of changes of one or more of a channel quality indicator (CQI), a rank indicator (RI), CSI-RS resource indicator (CRI), SS/PBCH resource block indicator (SSBRI), Layer Indicator (LI) or a precoder matrix indicator (PMI). For the method of FIG. 2, a UE may support various combination of CSI-RS reporting configurations. In some cases, a UE may be configured to support various periodic, semi-periodic and aperiodic CSI-RS configurations that are activated via an Sidelink Control Information (SCI) with a CSI request field. In such cases, the sidelink CSI-RS may be transmitted in resource blocks associated with the CSI activation.

For the method of FIG. 2, the controlling transmitting, by the user node to the network node, information indicating that there is a predicted decrease in radio network performance may include controlling transmitting a flag indicating that there is a predicted decrease in radio network performance of the user node-network node (e.g., UE-gNB) radio link. Thus, as a simple example, the information indicating a predicted decrease in radio network performance of the UE-gNB link may simply be a flag or a bit set to a value that indicates an expected decrease in radio network performance for the UE-gNB link. The gNB may then take one or more corrective actions, e.g., to improve radio network performance for the UE. More detailed and/or different information may be transmitted to the gNB to notify the network node/gNB.

For the method of FIG. 2, the controlling transmitting, by the user node to the network node, information indicating that there is a predicted decrease in radio network performance may include controlling transmitting at least one of the following: information indicating at least one radio network performance parameter; and/or information indicating a predicted value or a predicted level of change for the at least one radio network performance parameter for the radio link between the first user node and the network node. Thus, for example, the UE may transmit information indicating a radio network performance parameter and an expected or predicted value or a predicted change in a value of such radio network performance parameter (e.g., information indicating one or more of: RSRP, and a 12% decrease in RSRP of UE1-gNB radio link is expected within the next 350 ms). Other radio network performance parameters may be used.

For the method of FIG. 2, the information indicating the predicted value or a predicted level of change in a radio network performance parameter may include information indicating at least one of the following for the radio link between the user node and the network node (UE-gNB radio link): a predicted value of or a predicted decrease an amplitude, a received power, a reference signal received power (RSRP), a reference signal received quality (RSRQ), or received signal strength of a reference signal received from the network node; a predicted value of or a predicted decrease in signal-to-interference plus noise ratio (SINR); a predicted value of or a predicted increase in an error rate or block error rate; a predicted value of or a predicted increase in latency; a predicted value of or a predicted change in a modulation order and/or coding rate; a predicted value of or a predicted change in channel state information (CSI) including one or more of a channel quality indicator (CQI), a rank indicator (RI), CSI-RS resource indicator (CRI), SS/PBCH resource block indicator (SSBRI), Layer Indicator (LI) or a precoder matrix indicator (PI). For the method of FIG. 2, a UE may support various combination of CSI-RS reporting configurations. In some cases, a UE may be configured to support various periodic, semi-periodic and aperiodic CSI-RS configurations that are activated via an Sidelink Control Information (SCI) with a CSI request field. In such cases, the sidelink CSI-RS may be transmitted in resource blocks associated with the CSI activation. For example, the information indicating a predicted value may indicate an expected future value (e.g., within a specific time threshold of, e.g., 500 ms) of a RSRP of the UE-gNB link of −120 dBm, or may indicate an expected change or decrease in RSRP for the UE-gNB link, e.g., an expected decrease of 15% of RSRP of the UE-gNB link, e.g., as measured by the UE. A time or time threshold may or may not be indicated.

The method of FIG. 2 may further include receiving, by the user node, information associated with a corrective action performed by the network node in response to the predicted decrease in radio network performance, wherein the corrective action may include at least one of the following: a transmit power control for the user node; a timing advance adjustment; a change in a modulation order and/or coding rate for the first user node; a handover of the user node from the network node to a different network node; a load balancing of traffic for the user node between two or more network nodes; a link adaptation for the radio link between the user node and the network node; and/or a scheduling of resources for the user node for at least one of uplink or downlink communication. As an example, in response to the user node controlling transmitting an indication that there is a predicted decrease in radio network performance, the user node may receive, from the network node, control information or a command to increase UE transmission power, to change the modulation and coding scheme (MCS) used by the UE for UL and/or DL transmission, scheduling of additional resources for the UE, and/or a command from the network node to cause the UE to perform a handover or cell change to a different cell or different gNB or network node, as examples.

### A User Node or UE (e.g., UE1) May Both Transmit a SL Signal and Receive and Measure a Signal Including Reflection(s) of the Transmitted SL Signal:

As shown in FIGS. 4-6, the method or flow chart of FIG. 2 may include a user node or UE (e.g., UE1) that both transmits a SL signal and receives one or more reflections of the SL signal, and UE1 measures channel information for the SL channel based on the received signal or reflection(s). This situation or type of system may be similar to a mono-static radar operation in which one device both transmits a sensing signal and receives the reflected signal for measurement. Different types of signals may be transmitted as the SL signal, such as a reference signal, a Frequency-Modulated Continuous Wave radar signal, or other signal. For example, for the method of FIG. 2, the method may include controlling receiving, by the user node (e.g., UE1), a signal including at least one reflection of the Frequency-Modulated Continuous Wave radar signal; wherein the determining channel information comprises determining or measuring, by the user node, channel information for the sidelink channel, based on the received signal. Also, for example, for the method of FIG. 2, the controlling transmitting a sidelink signal may include controlling transmitting, by the user node (e.g., UE1), a Frequency-Modulated Continuous Wave radar signal using the sidelink resources of the sidelink channel; the method further comprising controlling receiving, by the user node, a signal including at least one reflection of the Frequency-Modulated Continuous Wave radar signal; wherein the determining channel information comprises determining or measuring, by the user node, channel information for the sidelink channel, based on the received signal. FIGS. 4-6 illustrates features and/or examples of this operation, in which UE1 may both transmit a SL signal, and receive (and measure channel information for) a signal that includes at least one reflection of the transmitted SL signal.

FIGS. 4-6 are figures that illustrate operation of a system in which the transmitting user node or UE (UE1 that transmits the SL signal) also receives a signal that includes at least one reflection of the transmitted SL signal that was transmitted by UE1, and wherein UE1 measures channel information of the received (e.g., at least partially passively reflected) signal.

FIG. 4 is a diagram illustrating a system that includes user nodes or UEs and a gNB/network node in which UE1 both transmits a sidelink signal and receives the reflected sidelink signal to measure channel information for the received signal (e.g., mono-static radar operation). A UE1 may be in communication with one or more other UEs via sidelink channel, and the UE may also be in communication with gNB 310 via a UE1-gNB radio link. An object 312 may at least partially passively reflect the transmitted SL signal.

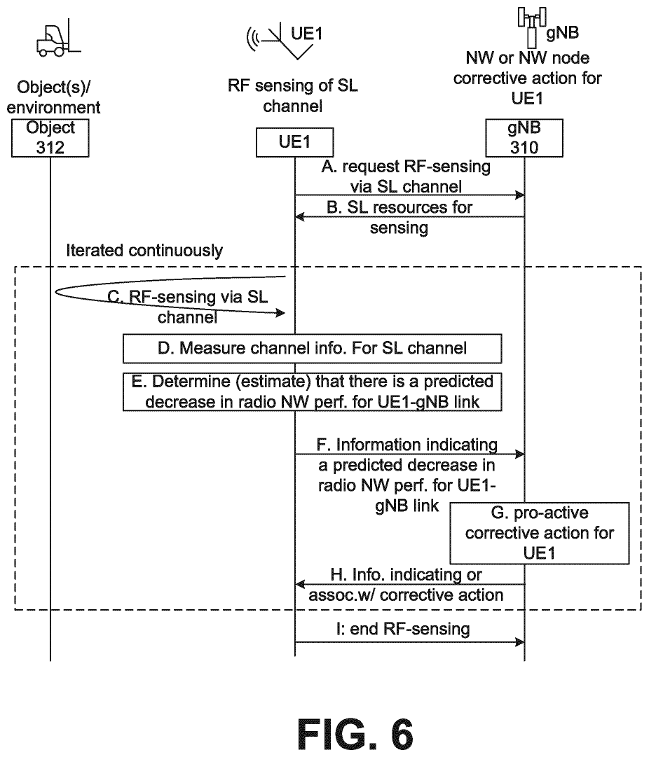

FIG. 6 is a diagram illustrating operation of a system, including UE1, in which the UE1 both transmits a SL signal, and measures channel information on the at least partially passively reflected SL signal that is received by UE1. In one example, the SL signal transmitted by UE1 in FIGS. 4 and 6 may be or may include a Frequency-Modulated Continuous Wave (FMCW) radar signal (which may also be referred to as a Chirp spread spectrum (CSS) signal). The SL signal may alternatively be a reference signal, or other signal. FIG. 5 is a diagram illustrating an example of a FMCW radar signal, in which the FMCW radar signal linearly increases (or linearly decreases) in frequency delta f over a time period delta t. The UE may transmit either a linearly increasing FMCW radar signal (up-chirp signal), or a linearly decreasing radar signal (down-chirp signal), and may perform correlation using the opposite FMCW signal to detect a received FMCW signal. Phase, amplitude, doppler shift, received power (e.g., reference signal received power (RSRP)) and/or other signal parameters of the received reflected signal may be measured by UE1.

Referring to FIGS. 4 and 6, at operations A and B of FIG. 6, UE1 may send a request and receive SL resources for sensing from gNB 310, or may otherwise determine SL resources to be used for transmitting a SL signal for sensing. Sensing may include, for example, or may refer to, sensing or detecting channel information of a SL channel based on the transmitted SL signal. At operation C of FIG. 6, and operation 1) of FIG. 4, the UE1 transmits a SL signal (e.g., a reference signal, a FMCW radar signal, a CSS signal, and/or other signal) via the SL resources of the SL channel. At operation D of FIG. 6 and operations 2) and 3) of FIG. 4, UE1 receives a signal, including at least one reflection of the transmitted SL signal that has been at least partially passively reflected by object 312 (for example), and (UE1) measures channel information for the SL channel based of the received signal. At operation E of FIG. 6, UE1 determines or estimates that there is a predicted decrease in radio network performance (e.g., an expected decrease or drop in SINR or RSRP, or other radio network performance parameter(s)) for the UE1-gNB radio link, based at least on the channel information for the SL channel of the UE1. At operation F of FIG. 6, UE1 may send to gNB 310 information indicating that there is a predicted (or expected) decrease in radio network performance for the UE1-gNB radio link. At operation G of FIG. 6, gNB 310 may perform a corrective action for UE1, e.g., to improve radio network performance of the UE1-gNB radio link and/or to perform a handover or cell change of UE1 to a new cell and/or network node. At operation H) of FIG. 6, gNB 310 may send to UE1 information indicating and/or associated with the corrective action performed by gNB 310, e.g., a command to increase transmission power, a handover or cell change command for UE1, an allocation of resources, an instruction to use a different modulation and coding scheme (MCS) for UL and/or DL transmissions, or other corrective action, e.g., which may address or respond to the predicted decrease in radio network performance of the UE1-gNB radio link. At operation I of FIG. 6, the RF or SL sensing is completed or ended.

### Different User Nodes or UEs (e.g., UE1, UE2) May Transmit a SL Signal and Measure Channel Information of a Received Signal Including Reflection(s) of the Transmitted SL Signal:

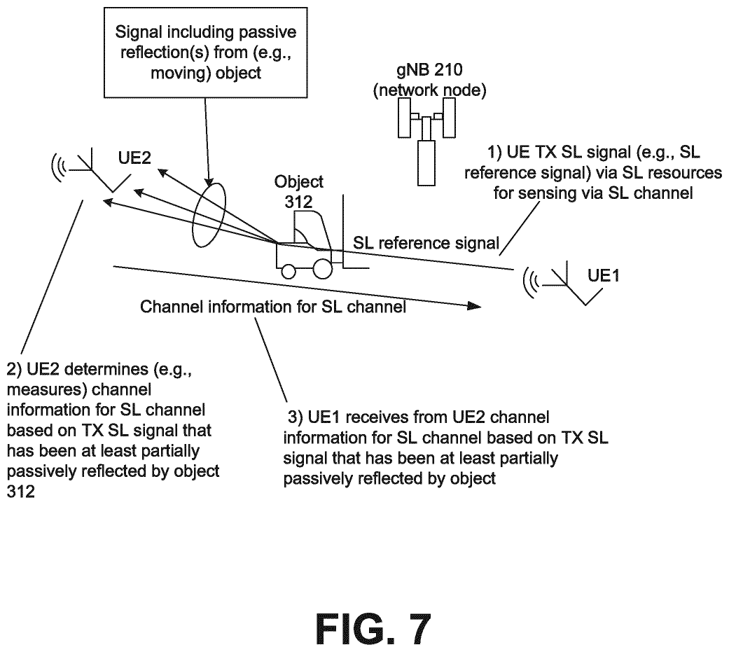

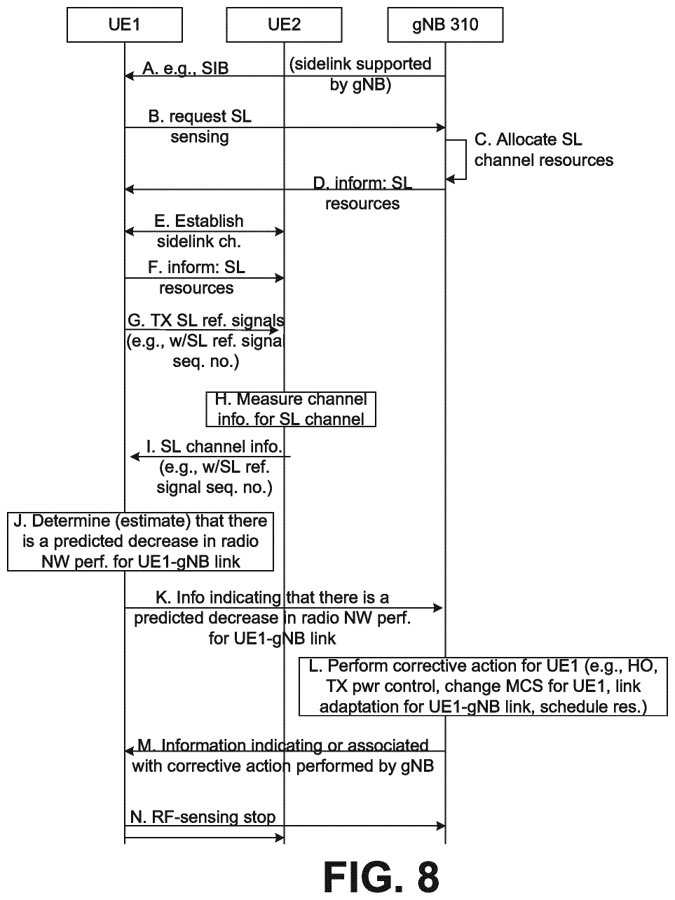

As shown in FIGS. 7-8, the method or flow chart of FIG. 2 may include different user nodes or UEs that transmit a SL signal (e.g., UE1), and receive and measure a signal (e.g., UE2) that includes at least a reflection of the transmitted SL signal. FIGS. 7-8 are figures that illustrate operation of a system in which UE1 transmits a SL signal, and one or more other UEs (e.g., UE2) receives the SL signal (transmitted by UE1), including at least one reflection of the SL signal that was transmitted by UE1, and UE2 measures channel information of the received (reflected) signal. FIG. 7 is a diagram illustrating a system that includes UEs and a gNB/network node in which UE1 transmits a SL signal, and UE2 measures channel information of the SL channel based on the at least partially passively reflected SL signal, which may be similar to a bi-static radar operation in which a first (transmitter) device transmits a signal and a second (receiving) device receives a reflected signal. In FIG. 7, UE1 and UE2 are in communication via a SL channel, and UE1 may be in communication with gNB 310 via a UE1-gNB radio link. FIG. 8 is a diagram illustrating operation of the system according to FIG. 7.

At operation A of FIG. 8, UE1 may receive system information (e.g., system information block or SIB) from gNB 310 indicating that gNB 310 supports SL communications and/or supports RF sensing via SL channels. At operation B of FIG. 8, UE1 sends a request to gNB 310 a request for SL resources for SL channel sensing. At operation C of FIG. 8, the gNB 310 allocates SL resources for a SL channel, and at operation D, gNB 310 sends a message to UE1 indicating the allocated SL resources. At operation E, UE1 establishes a SL channel or SL communication with one or more other UEs, such as with UE2. At operation F, UE1 informs UE1 and other UEs of the SL resources of the SL channel that will be used for transmission of a SL signal (e.g., a reference signal, or other signal) for RF-sensing of the SL channel. At operation G of FIG. 8, and operation 1) of FIG. 7, the UE1 transmits the SL reference signal via SL resources of the SL channel. At operation H of FIG. 8 and operation 2) of FIG. 7, UE2 measures channel information for the SL channel based on the transmitted SL reference signal that has been at least partially passively reflected by object 312. The SL reference signal transmitted by UE1 may include, for example, a reference signal sequence number to identify different reference signals transmitted. At operation I of FIG. 8 and operation 3) of FIG. 7, UE2 may transmit to UE1 (and UE1 may thus receive) the measured channel information for the SL channel, and which may also include or indicate a reference signal sequence number(s) on which the channel information for the SL channel was based (or measured). UE1 may thus match or associate channel information received from different UEs within a SL group as being based on the same SL reference signal, e.g., based on the SL reference signal sequence number that may be provided with the channel information sent to UE1. At operation J of FIG. 8, UE1 may determine that there is a predicted or estimated future decrease in radio network performance of the UE1-gNB radio link, based on the received channel information (from one or more UEs) and a model that may map SL channel information to predicted radio network performance of the UE1-gNB radio link. At operation K of FIG. 8, UE1 may transmit to gNB 310 information indicating that there is a predicted or (expected future) decrease in radio network performance of the UE1-gNB radio link. At operation L of FIG. 8, gNB 310 may perform a corrective action, e.g., to improve performance (and/or avoid at least some of the predicted decrease in radio network performance) of the UE1-gNB radio link and/or assist in establishing a new radio link for the UE via handover or cell change. At operation M of FIG. 8, gNB 310 may send information to UE1 indicating or associated with the corrective action, e.g., a command to cause UE to increase transmission power, to adjust a MCS for DL or UL transmission, to perform a handover or cell change, or other corrective action for UE1. At operation N of FIG. 8, UE1 may notify UE2 or other UEs of the SL group, and/or gNB 310, that the RF sensing for SL channel is completed or stopped.

For example, with respect to FIGS. 7-8, and method of FIG. 2, the model may include a neural network model; the sidelink (SL) signal may include a sidelink reference signal; and the user node (e.g., UE1) comprises a first user node, wherein the method may include informing, by the first user node, a second user node (e.g., UE2) of the sidelink resources for the transmission of the sidelink reference signal for sensing; wherein the controlling transmitting the sidelink reference signal may include controlling transmitting, by the first user node, the sidelink reference signal using the sidelink resources to the second user node; wherein the determining channel information for the sidelink channel may include controlling receiving, by the first user node from the second user node, channel information for a sidelink channel between the first user node and the second user node, wherein the channel information is determined by the second user node based on the sidelink reference signal transmitted by the first user node that has been at least partially passively reflected from at least one object within a physical environment;

Also, with respect to FIGS. 7-8, and method of FIG. 2, the method may further include training, by the first user node (e.g., UE1), the neural network model based on a plurality of received channel information for the sidelink channel and a plurality of detected decreases in radio network performance for the radio link between the first user node and the network node (e.g., gNB) that were detected within a threshold time period of time after receiving a channel information for the sidelink channel.

Also, with respect to FIGS. 7-8, and method of FIG. 2, the method may further include performing supervised training of the neural network model, including, e.g.: receiving, by the first user node from the second user node, a plurality of channel information of the sidelink channel based on one or more transmitted sidelink reference signals; receiving, by the first user node from the network node, a network node reference signal; determining, by the first user node, within a time threshold of receiving the channel information, a level of change in one or more radio network performance parameters for the radio link between the first user node and the network node based on the network node reference signal received from the network node; and updating weights of the neural network model to map the plurality of received channel information of the sidelink channel to a level of change in one or more of the radio network performance parameters for the radio link between the first user node and the network node, in which the determining a level of change in one or more radio network performance parameters occurs within a threshold time period of receiving the channel information.

Also, with respect to FIGS. 7-8, and method of FIG. 2, the channel information received from the second user node may include a first channel information, the method further including: determining, by the first user node, a second channel information based on the sidelink reference signal transmitted by the first user node that has been at least partially passively reflected from at least one object within a physical environment; determining, by the first user node based at least on the first and second channel information and the model, that there is the predicted decrease in the radio network performance for the radio link between the first user node and the network node.

Also, with respect to FIGS. 7-8, and method of FIG. 2, the method may further including determining, by the first user node, a reference signal sequence number of the transmitted sidelink reference signal; controlling receiving, by the first user node from the second user node, a reference signal sequence number that identifies the sidelink reference signal upon which the first channel information has been determined by the second user node; determining, by the first user node based on the reference signal sequence numbers, that the first channel information and the second channel information are based on the same sidelink reference signal transmitted by the first user node.

Training and/or Use of Neural Network Model to Predict Decrease in Radio Network Performance of UE-gNB Radio Link

A UE may train a model 320 (FIG. 3) (e.g., such as an Artificial Intelligence (AI) neural network (NN) model, which may simply be referred to as a neural network (NN) model), based on measured channel information of a SL channel and associated (e.g., associated in time, such as typically occurring within a time period after or within a time window around) radio network performance information for the UE-gNB radio link, e.g., to predict an expected or future decrease in radio network performance of the UE-gNB radio link. Then, after the NN model is trained, channel information for a SL channel (measured by UE1, or measured by UE2 and reported to UE1) may be input to the NN model, and the NN model may output the predicted (or future expected) radio network performance information for the UE-gNB radio link. For example RSRP values of the SL channel may be input to the NN model, and the NN model may output expected or predicted RSRP values of the UE-gNB radio link (e.g., that typically occur within a time window of, e.g., 400 ms). The UE (e.g., UE1) may then send a notification to the gNB if the predicted RSRP value of the UE-gNB radio link is less than a threshold value, e.g., less than −100 dBm. In this manner, channel information (e.g., RSRP values) of a SL channel for a UE may be used to predict a future decrease in radio network performance (e.g., future or expected RSRP value(s)) of a UE-gNB radio link. Further examples and/or illustrative details are described hereinbelow.

A mode, e.g., a neural network model 320 (FIG. 3) may be trained for a specific task. In this example, the NN model 320 is trained to estimate or predict a decrease in radio network performance of a UE-gNB radio link based on channel information of a SL channel for the UE.

In general, one or more nodes (e.g., BS, gNB, eNB, RAN node, user node, UE, user device, relay node, or other node) within a wireless network may use or employ a model (e.g., 320, FIG. 3), e.g., such as, for example a neural network model (e.g., which may be referred to as a neural network, an artificial intelligence (AI) neural network, an Al neural network model, an Al model, a machine learning model or algorithm, or other term) to perform, or assist in performing, one or more functions. Other types of models may also be used. Neural networks may be or may include computational models used in machine learning made up of nodes organized in layers. The nodes are also referred to as artificial neurons, or simply neurons, and perform a function on provided input to produce some output value. A neural network requires a training period to learn the parameters, i.e., weights, used to map the input to a desired output. The mapping occurs via the function. Thus, the weights are weights for the mapping function of the neural network. Each neural network model may be trained for a specific task.

To provide the output given the input, the neural network model must be trained, which may involve learning the proper value for a large number of parameters (e.g., weights) for the mapping function. The parameters are also commonly referred to as weights as they are used to weight terms in the mapping function. This training may be an iterative process, with the values of the weights being tweaked over many (e.g., thousands) of rounds of training until arriving at the optimal, or most accurate, values (or weights). In the context of neural networks (neural network models), the parameters may be initialized, often with random values, and a training optimizer iteratively updates the parameters (weights) of the neural network to minimize error in the mapping function. In other words, during each round, or step, of iterative training the network updates the values of the parameters so that the values of the parameters eventually converge on the optimal values.

Neural network models may be trained in either a supervised or unsupervised manner, as examples. In supervised learning, training examples are provided to the neural network model or other machine learning algorithm. A training example includes the inputs and a desired or previously observed output. Training examples are also referred to as labeled data because the input is labeled with the desired or observed output. In the case of a neural network, the network learns the values for the weights used in the mapping function that most often result in the desired output when given the training inputs. In unsupervised training, the neural network model learns to identify a structure or pattern in the provided input. In other words, the model identifies implicit relationships in the data. Unsupervised learning is used in many machine learning problems and typically requires a large set of unlabeled data.

According to an example embodiment, the learning or training of a neural network model may be classified into (or may include) two broad categories (supervised and unsupervised), depending on whether there is a learning “signal” or “feedback” available to a model. Thus, for example, within the field of machine learning, there may be two main types of learning or training of a model: supervised, and unsupervised. The main difference between the two types is that supervised learning is done using known or prior knowledge of what the output values for certain samples of data should be. Therefore, a goal of supervised learning may be to learn a function that, given a sample of data and desired outputs, best approximates the relationship between input and output observable in the data. Unsupervised learning, on the other hand, does not have labeled outputs, so its goal is to infer the natural structure present within a set of data points.

Supervised learning: The computer is presented with example inputs and their desired outputs, and the goal may be to learn a general rule that maps inputs to outputs. Supervised learning may, for example, be performed in the context of classification, where a computer or learning algorithm attempts to map input to output labels, or regression, where the computer or algorithm may map input(s) to a continuous output(s). Common algorithms in supervised learning may include, e.g., logistic regression, naive Bayes, support vector machines, artificial neural networks, and random forests. In both regression and classification, a goal may include to find specific relationships or structure in the input data that allow us to effectively produce correct output data. As special cases, the input signal can be only partially available, or restricted to special feedback: Semi-supervised learning: the computer is given only an incomplete training signal: a training set with some (often many) of the target outputs missing. Active learning: the computer can only obtain training labels for a limited set of instances (based on a budget), and also has to optimize its choice of objects to acquire labels for. When used interactively, these can be presented to the user for labeling. Reinforcement learning: training data (in form of rewards and punishments) is given only as feedback to the program's actions in a dynamic environment, e.g., using live data.

Unsupervised learning: No labels are given to the learning algorithm, leaving it on its own to find structure in its input. Some example tasks within unsupervised learning may include clustering, representation learning, and density estimation. In these cases, the computer or learning algorithm is attempting to learn the inherent structure of the data without using explicitly-provided labels. Some common algorithms include k-means clustering, principal component analysis, and auto-encoders. Since no labels are provided, there may be no specific way to compare model performance in most unsupervised learning methods.

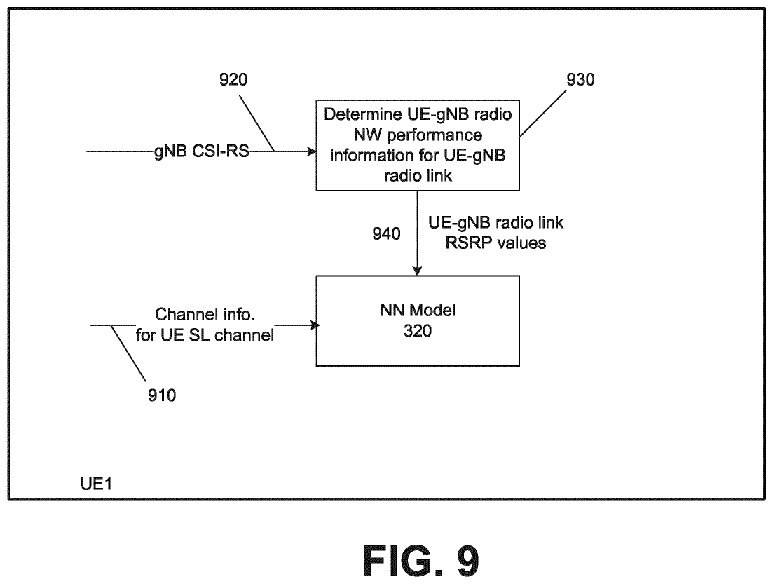

FIG. 9 is a diagram illustrating an example of UE1 training a neural network model 320 using supervised training. UE1 may include a NN model 320, which may include a plurality of weights that may be adjusted as part of the NN model training. UE1 may receive via line 920 gNB reference signals, such as synchronization signal block (SSB) reference signals or channel state information (CSI-RS) reference signals. At 930, the UE1 may determine (e.g., measure) UE-gNB radio network performance information for the UE-gNB radio link, e.g., such as SINR, RSRP, RSRQ, channel state information, or other radio network information that may indicate a performance of the UE1-gNB radio link. While many different radio network parameters may be used to indicate or determine the radio network performance of the UE1-gNB radio link, reference signal received power (RSRP) (measured by UE1) of the UE1-gNB radio link is used in this example. Therefore, at 940, UE1 may output to NN model 320 UE-gNB radio link RSRP values. Also, at 910, NN model 320 may receive as an input the SL channel information for the UE SL channel measured by UE1 and/or measured by UE2 and forwarded to UE1. In this example the SL channel information may be RSRP, phase and/or doppler shift (at one or more antennas) of the received (reflected) signal of the SL channel. Training of NN model 320 may include, for example, adjusting weights of the NN model to cause the NN model 320 to output the UE-gNB RSRP values (e.g., which may be received within a threshold time period or time window after receiving a SL channel information) based on received SL channel information.

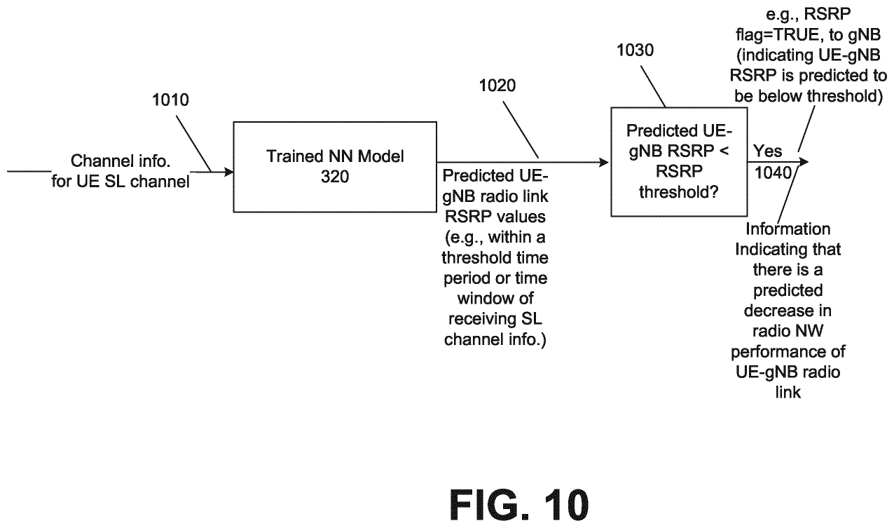

FIG. 10 is a diagram illustrating an example of UE1 using a neural network model to predict a decrease in radio network performance of a UE1-gNB radio link. At 1010, SL channel information (e.g., RSRP values of the SL channel) are input to trained NN model 320. At 1020, the NN model 320 outputs predicted UE-gNB radio link RSRP values (e.g., which are predicted or expected to occur for the UE-gNB radio link within a threshold time period or time window of receiving the SL channel information). At 1030, UE1 may determine whether the predicted UE-gNB RSRP is less than a RSRP threshold? (e.g., is the RSRP value of the SL channel less than −110 dBm?) If this condition is met (e.g., the RSRP value of the SL channel is less than −110 dBm, or UE-gNB radio link RSRP has decreased by a threshold amount over a time period), then such a RSRP value of the UE1-gNB radio link is or indicates a predicted or expected decrease (below a threshold) of radio network performance of the UE1-gNB radio link. In such a case (where this condition is met, indicating a predicated decrease in UE1-gNB radio link performance), at 1040, UE1 may transmit or send to gNB information indicating that there is a predicted decrease in radio network performance of UE1-gNB radio link. For example, UE1 may set or transmit a flag to gNB a flag, e.g., setting a RSRP flag=TRUE, indicating UE1-gNB RSRP is predicted to be below threshold, in order to notify the gNB that there is a predicted or expected decrease in radio network performance for the UE1-gNB radio link. The gNB may then perform one or more corrective actions for UE1, e.g., where such corrective action(s) may increase the likelihood that the UE1 will maintain a connection to the network and/or maintain performance of such UE1 network connection above some minimum required performance. In this manner, channel information for a SL channel may be used to estimate or predict a decrease in radio network performance of a UE-gNB radio link, thereby enabling the gNB or network to perform one or more corrective actions.

Some further examples will be provided.

Example 1. A method may include:
determining, by a user node, sidelink resources of a sidelink channel for transmission of a sidelink signal for sensing (e.g., FIG. 3, operation 1), UE1 determines or obtains SL resources of a SL channel);
controlling transmitting, by the user node, the sidelink signal using the sidelink resources of the sidelink channel (e.g., FIG. 3, operation 2), UE1 transmits a SL signal (e.g., a SL reference signal or a FMCW radar signal, or other SL signal) for sensing;
determining, by the user node, channel information for the sidelink channel, wherein the channel information is based on the transmitted sidelink signal that has been at least partially passively reflected from at least one object within a physical environment (e.g., FIG. 3, operation 3), UE1 determines (e.g., measures or receives from UE2) channel information for SL channel based on the transmitted SL signal that has been at least partially passively reflected by object 312);
determining, by the user node based at least on the channel information for the sidelink (SL) channel and a model, that there is a predicted decrease in a radio network performance for a radio link between the user node and a network node (e.g., FIG. 3, operation 4), UE1 determines that there is a predicted decrease in radio network performance of UE1-gNB radio link based on model 320 (e.g., provided at UE1) and the channel information for the SL channel); and
controlling transmitting, by the first user node to the network node, information indicating that there is a predicted decrease in radio network performance for the radio link between the user node and the network node, to enable the network node to perform a corrective action based on the predicted decrease in radio network performance (e.g., FIG. 3, operation 5), UE1 transmits information to gNB indicating that there is a predicted decrease in radio network performance for the UE1-gNB link).

Example 2. The method of example 1 wherein the model comprises a neural network model (e.g., neural network mode 320, FIGS. 9-10).

Example 3. The method of any of examples 1-2 wherein the predicted decrease in radio network performance is predicted to occur within a time threshold of receiving the channel information, based on the neural network model.

Example 4. The method of any of examples 1-3 wherein the determining, by the user node, sidelink resources for transmission of a sidelink reference signal for sensing comprises the user node performing at least one of:
selecting the sidelink resources for transmission of the sidelink reference signal for sensing (e.g., operation 1) of FIG. 3, UE1 selects the SL resources for transmission); or
obtaining (e.g., operation 1) of FIG. 3, UE1 requests and obtains the SL resources from the gNB) the sidelink resources from the network node based on the following: controlling transmitting, by the user node to the network node, a request for sidelink resources for transmission of a sidelink reference signal for sensing; and controlling receiving, by the user node from the network node, information indicating the sidelink resources for transmitting the sidelink reference signal for sensing.

Example 5. The method of any of examples 1-4, wherein the channel information comprises at least one of the following: a value of at least one channel-related parameter, including a value of at least one of: an amplitude, a received power, a reference signal received power (RSRP), or a received signal strength of the sidelink reference signal; a phase of the sidelink reference signal; a doppler shift at one or more antenna ports; a channel state information (CSI), including one or more of a channel quality indicator (CQI), a rank indicator (RI), CSI-RS resource indicator (CRI), SS/PBCH resource block indicator (SSBRI), Layer Indicator (LI) or a precoder matrix indicator (PI); a processed channel-related parameter, including at least one of: a mean, median, or variance of a plurality of values of a channel-related parameter; a change in at least one channel-related parameter, including a change or a pattern of changes of at least one of: an amplitude, a received power, a reference signal received power (RSRP), or a received signal strength of the sidelink reference signal; a phase of the received reference signal; a doppler shift at one or more antenna ports; a channel state information (CSI), including a change or a pattern of changes of one or more of a channel quality indicator (CQI), a rank indicator (RI), CSI-RS resource indicator (CRI), SS/PBCH resource block indicator (SSBRI), Layer Indicator (LI) or a precoder matrix indicator (PI).

Example 6. The method of any of examples 1-5, wherein the controlling transmitting, by the user node to the network node, information indicating that there is a predicted decrease in radio network performance comprises controlling transmitting at least one of the following: information indicating at least one radio network performance parameter; and/or information indicating a predicted value or a predicted level of change for the at least one radio network performance parameter for the radio link between the user node and the network node. Thus, for example, the UE may transmit information indicating a radio network performance parameter, such as information indicating RSRP, and information indicating a 12% decrease in RSRP of UE1-gNB radio link is expected within the next 350 ms). Other radio network performance parameters may be used.

Example 7. The method of example 6, wherein the information indicating the predicted value or a predicted level of change in a radio network performance parameter comprises information indicating at least one of the following for the radio link between the user node and the network node: a predicted value of or a predicted decrease an amplitude, a received power, a reference signal received power (RSRP), a reference signal received quality (RSRQ), or received signal strength of a reference signal received from the network node; a predicted value of or a predicted decrease in signal-to-interference plus noise ratio (SINR); a predicted value of or a predicted increase in an error rate or block error rate; a predicted value of or a predicted increase in latency; a predicted value of or a predicted change in a modulation order and/or coding rate; a predicted value of or a predicted change in channel state information (CSI) including one or more of a channel quality indicator (CQI), a rank indicator (RI), CSI-RS resource indicator (CRI), SS/PBCH resource block indicator (SSBRI), Layer Indicator (LI) or a precoder matrix indicator (PI).

Example 8. The method of any of examples 1-7, further comprising: receiving, by the user node, information associated with a corrective action performed by the network node in response to the predicted decrease in radio network performance, wherein the corrective action comprises at least one of the following: a transmit power control for the user node; a timing advance adjustment; a change in a modulation order and/or coding rate for the first user node; a handover of the user node from the network node to a different network node; a load balancing of traffic for the user node between two or more network nodes; a link adaptation for the radio link between the user node and the network node; and/or a scheduling of resources for the user node for at least one of uplink or downlink communication.

Example 9. The method of any of examples 1-8, wherein: the model comprises a neural network model (e.g., NN model 320, FIGS. 9-10); the sidelink signal comprises a sidelink reference signal; and the user node (e.g., UE1) comprises a first user node, wherein: the method comprising informing, by the first user node, a second user node (e.g., UE2) of the sidelink resources for the transmission of the sidelink reference signal for sensing (e.g., see FIGS. 7 and/or 8); wherein the controlling transmitting the sidelink reference signal comprises controlling transmitting, by the first user node, the sidelink reference signal using the sidelink resources to the second user node; wherein the determining channel information for the sidelink channel comprises controlling receiving, by the first user node from the second user node, channel information for a sidelink channel between the first user node and the second user node, wherein the channel information is determined by the second user node based on the sidelink reference signal transmitted by the first user node that has been at least partially passively reflected from at least one object within a physical environment;

Example 10. The method of example 9, the method further comprising: training, by the first user node (e.g. UE1), the neural network model based on a plurality of received channel information for the sidelink channel and a plurality of detected decreases in radio network performance for the radio link between the first user node and the network node that were detected within a threshold time period of time after receiving a channel information for the sidelink channel (e.g., see training of NN model 320, FIGS. 9-10 and related text as examples).

Example 11. The method of any of examples 9-10, the method further comprising performing supervised training of the neural network model, comprising: receiving, by the first user node (UE1) from the second user node (e.g., UE2), a plurality of channel information of the sidelink channel based on one or more transmitted sidelink reference signals; receiving, by the first user (e.g. UE1) node from the network node, a network node reference signal; determining, by the first user node, within a time threshold of receiving the channel information, a level of change in one or more radio network performance parameters for the radio link between the first user node and the network node based on the network node reference signal received from the network node; and updating weights (e.g., updating weights of NN model 320, FIGS. 9-10) the neural network model to map the plurality of received channel information of the sidelink channel to a level of change in one or more of the radio network performance parameters for the radio link between the first user node and the network node, in which the determining a level of change in one or more radio network performance parameters occurs within a threshold time period of receiving the channel information.

For example, UE1 may include a NN model 320, which may include a plurality of weights that may be adjusted as part of the NN model training. UE1 may receive via line 920 gNB reference signals, such as synchronization signal block (SSB) reference signals or channel state information (CSI-RS) reference signals. At 930, the UE1 may determine (e.g., measure) UE-gNB radio network performance information for the UE-gNB radio link, e.g., such as SINR, RSRP, RSRQ, channel state information, or other radio network information that may indicate a performance of the UE1-gNB radio link. While many different radio network parameters may be used to indicate or determine the radio network performance of the UE1-gNB radio link, reference signal received power (RSRP) (measured by UE1) of the UE1-gNB radio link is used in this example. Therefore, at 940, UE1 may output to NN model 320 UE-gNB radio link RSRP values. Also, at 910, NN model 320 may receive as an input the SL channel information for the UE SL channel measured by UE1 and/or measured by UE2 and forwarded to UE1. In this example the SL channel information may be RSRP, phase and/or doppler shift (at one or more antennas) of the received (reflected) signal of the SL channel. Training of NN model 320 may include, for example, adjusting weights of the NN model to cause the NN model 320 to output the UE-gNB RSRP values (e.g., which may be received within a threshold time period or time window after receiving a SL channel information) based on received SL channel information.

Example 12. The method of any of examples 9-11, wherein the channel information received from the second user node comprises a first channel information, further comprising: determining, by the first user node, a second channel information based on the sidelink reference signal transmitted by the first user node that has been at least partially passively reflected from at least one object within a physical environment; determining, by the first user node based at least on the first and second channel information and the model, that there is the predicted decrease in the radio network performance for the radio link between the first user node and the network node.

Example 13. The method of example 12, further comprising: determining, by the first user node, a reference signal sequence number of the transmitted sidelink reference signal; controlling receiving, by the first user node from the second user node, a reference signal sequence number that identifies the sidelink reference signal upon which the first channel information has been determined by the second user node; determining, by the first user node based on the reference signal sequence numbers, that the first channel information and the second channel information are based on the same sidelink reference signal transmitted by the first user node.

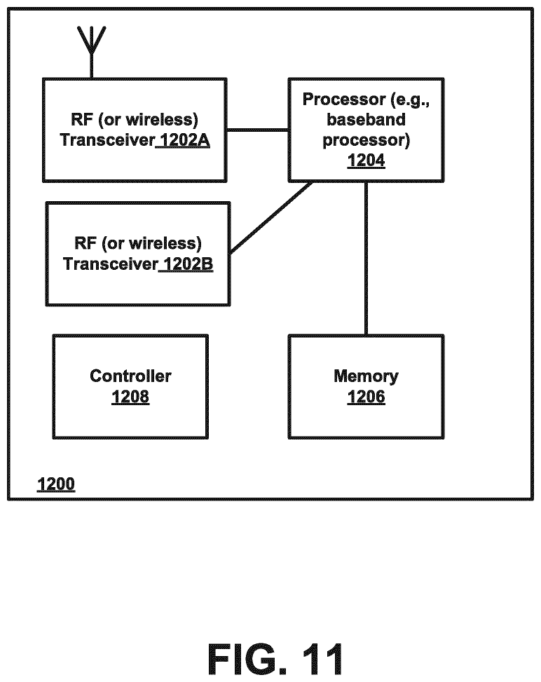

Example 14. A non-transitory computer-readable storage medium (e.g., memory 1206, FIG. 11) comprising instructions stored thereon that, when executed by at least one processor, are configured to cause a computing system to perform the method of any of examples 1-13.

Example 15. An apparatus (e.g., wireless station, FIG. 11) comprising means (e.g., processor 1204, memory 1206 and/or transceiver 1202A or 1202B) for performing the method of any of examples 1-13.

Example 16. An apparatus (e.g., wireless station, FIG. 11) comprising: at least one processor (processor 1204); and at least one memory (e.g., 1206, FIG. 11) including computer program code; the at least one memory and the computer program code configured to, with the at least one processor, cause the apparatus at least to perform the method of any of examples 1-13.

Example 17. The method of any of examples 1-7: the method further comprising controlling receiving, by the user node, a signal including at least one reflection of the sidelink signal that has been at least partially passively reflected from at least one object within the physical environment; wherein the determining channel information comprises determining or measuring, by the user node, channel information for the sidelink channel, based on the received signal (e.g., FIG. 4, UE1 both transmits a SL signal, and receives a signal that includes at least one reflection of the transmitted SL signal).

Example 18. The method of any of examples 1-7: wherein the controlling transmitting a sidelink signal comprises controlling transmitting, by the user node, a Frequency-Modulated Continuous Wave radar signal using the sidelink resources of the sidelink channel; the method further comprising controlling receiving, by the user node, a signal including at least one reflection of the Frequency-Modulated Continuous Wave radar signal that has been at least partially passively reflected from at least one object within the physical environment; wherein the determining channel information comprises determining or measuring, by the user node, channel information for the sidelink channel, based on the received signal (e.g., see FIGS. 4-5, where UE1 transmits a FMCW radar signal (example shown in FIG. 5) at operation 1) of FIG. 4, and receives a signal at operation 2), that includes at least one reflection of the FMCW radar signal).

Example 19. A non-transitory computer-readable storage medium (e.g., memory 1206, FIG. 11) comprising instructions stored thereon that, when executed by at least one processor, are configured to cause a computing system to perform the method of any of examples 1-7, 17 and 18.

Example 20. An apparatus comprising means (e.g., processor 1204, memory 1206 and/or transceiver 1202A, FIG. 11) for performing the method of any of examples 1-7, 17 and 18.

Example 21. An apparatus (e.g., wireless station, FIG. 11) comprising: at least one processor (processor 1204); and at least one memory (e.g., 1206, FIG. 11) including computer program code; the at least one memory and the computer program code configured to, with the at least one processor, cause the apparatus at least to perform the method of any of examples 1-7, 17 and 18.

FIG. 11 is a block diagram of a wireless station (e.g., user node, network node, or other node) 1200 according to an example embodiment. The wireless station 1200 may include, for example, one or more (e.g., two as shown in FIG. 11) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 11, a controller (or processor) 1208 may execute software and instructions, and may provide overall control for the station 1200, and may provide control for other systems not shown in FIG. 11, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G may be similar to that of LTE-advanced. 5G is likely to use multiple input—multiple output (MIMO) antennas, many more base stations or nodes than LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node may be operationally coupled to a remote radio head. It is also possible that node operations will be distributed among a plurality of servers, nodes or hosts. It should also be understood that the distribution of labour between core network operations and base station operations may differ from that of the LTE or even be non-existent.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a standalone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a backend component, e.g., as a data server, or that includes a middleware component, e.g., an application server, or that includes a frontend component, e.g., a client computer having a graphical user interface or a Web browser through which a user can interact with an embodiment, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-21. (canceled)

22. A method comprising:
determining, by a user node, sidelink resources of a sidelink channel for transmission of a sidelink signal for sensing;
controlling transmitting, by the user node, the sidelink signal using the sidelink resources of the sidelink channel;
determining, by the user node, channel information for the sidelink channel, wherein the channel information is based on the transmitted sidelink signal that has been at least partially passively reflected from at least one object within a physical environment;
determining, by the user node based at least on the channel information for the sidelink channel and a model, that there is a predicted decrease in a radio network performance for a radio link between the user node and a network node; and
controlling transmitting, by the first user node to the network node, information indicating that there is a predicted decrease in radio network performance for the radio link between the user node and the network node, to enable the network node to perform a corrective action based on the predicted decrease in radio network performance.

23. The method of claim 22, wherein the model comprises a neural network model.

24. The method of claim 22, wherein the predicted decrease in radio network performance is predicted to occur within a time threshold of receiving the channel information, based on the neural network model.

25. The method of claim 22, wherein the determining, by the user node, sidelink resources for transmission of a sidelink reference signal for sensing comprises the user node performing at least one of:
selecting the sidelink resources for transmission of the sidelink reference signal for sensing; or
obtaining the sidelink resources from the network node based on the following:
controlling transmitting, by the user node to the network node, a request for sidelink resources for transmission of a sidelink reference signal for sensing; and
controlling receiving, by the user node from the network node, information indicating the sidelink resources for transmitting the sidelink reference signal for sensing.

26. The method of claim 22, wherein the channel information comprises at least one of the following:
a value of at least one channel-related parameter, including a value of at least one of:
an amplitude, a received power, a reference signal received power (RSRP), or a received signal strength of the sidelink reference signal;
a phase of the sidelink reference signal;
a doppler shift at one or more antenna ports;
a channel state information (CSI), including one or more of a channel quality indicator (CQI), a rank indicator (RI), CSI-RS resource indicator (CRI), SS/PBCH resource block indicator (SSBRI), Layer Indicator (LI) or a precoder matrix indicator (PMI);
a processed channel-related parameter, including at least one of: a mean, median, or variance of a plurality of values of a channel-related parameter;
a change in at least one channel-related parameter, including a change or a pattern of changes of at least one of:
an amplitude, a received power, a reference signal received power (RSRP), or a received signal strength of the sidelink reference signal;
a phase of the received reference signal;
a doppler shift at one or more antenna ports;
a channel state information (CSI), including a change or a pattern of changes of one or more of a channel quality indicator (CQI), a rank indicator (RI), CSI-RS resource indicator (CRI), SS/PBCH resource block indicator (SSBRI), Layer Indicator (LI) or a precoder matrix indicator (PMI).

27. The method of claim 22, wherein the controlling transmitting, by the user node to the network node, information indicating that there is a predicted decrease in radio network performance comprises controlling transmitting at least one of the following:
information indicating at least one radio network performance parameter; and/or
information indicating a predicted value or a predicted level of change for the at least one radio network performance parameter for the radio link between the user node and the network node.

28. The method of claim 22, further comprising controlling receiving, by the user node, a signal including at least one reflection of the sidelink signal that has been at least partially passively reflected from at least one object within the physical environment;
wherein the determining channel information comprises determining or measuring, by the user node, channel information for the sidelink channel, based on the received signal.

29. The method of claim 22, wherein the controlling transmitting the sidelink signal comprises controlling transmitting, by the user node, a Frequency-Modulated Continuous Wave radar signal using the sidelink resources of the sidelink channel;
the method further comprising controlling receiving, by the user node, a signal including at least one reflection of the Frequency-Modulated Continuous Wave radar signal that has been at least partially passively reflected from at least one object within the physical environment;
wherein the determining channel information comprises determining or measuring, by the user node, channel information for the sidelink channel, based on the received signal.

30. An apparatus comprising:
at least one processor; and
at least one memory including computer program code;
the at least one memory and the computer program code configured to, with the at least one processor, cause the apparatus at least to
determine, by a user node, sidelink resources of a sidelink channel for transmission of a sidelink signal for sensing;
control transmitting, by the user node, the sidelink signal using the sidelink resources of the sidelink channel;
determine, by the user node, channel information for the sidelink channel, wherein the channel information is based on the transmitted sidelink signal that has been at least partially passively reflected from at least one object within a physical environment;
determine, by the user node based at least on the channel information for the sidelink channel and a model, that there is a predicted decrease in a radio network performance for a radio link between the user node and a network node, and
control transmitting, by the first user node to the network node, information indicating that there is a predicted decrease in radio network performance for the radio link between the user node and the network node, to enable the network node to perform a corrective action based on the predicted decrease in radio network performance.

31. The apparatus of claim 30, wherein the model comprises a neural network model.

32. The apparatus of claim 30, wherein the predicted decrease in radio network performance is predicted to occur within a time threshold of receiving the channel information, based on the neural network model.

33. The apparatus of claim 30, wherein the determining, by the user node, sidelink resources for transmission of a sidelink reference signal for sensing comprises causing the user node to perform at least one of:
selecting the sidelink resources for transmission of the sidelink reference signal for sensing; or
obtaining the sidelink resources from the network node based on the following:
controlling transmitting, by the user node to the network node, a request for sidelink resources for transmission of a sidelink reference signal for sensing; and
controlling receiving, by the user node from the network node, information indicating the sidelink resources for transmitting the sidelink reference signal for sensing.

34. The apparatus of claim 30, wherein the channel information comprises at least one of the following:
a value of at least one channel-related parameter, including a value of at least one of:
an amplitude, a received power, a reference signal received power (RSRP), or a received signal strength of the sidelink reference signal;
a phase of the sidelink reference signal;
a doppler shift at one or more antenna ports;
a channel state information (CSI), including one or more of a channel quality indicator (CQI), a rank indicator (RI), CSI-RS resource indicator (CRI), SS/PBCH resource block indicator (SSBRI), Layer Indicator (LI) or a precoder matrix indicator (PMI);
a processed channel-related parameter, including at least one of: a mean, median, or variance of a plurality of values of a channel-related parameter;
a change in at least one channel-related parameter, including a change or a pattern of changes of at least one of:
an amplitude, a received power, a reference signal received power (RSRP), or a received signal strength of the sidelink reference signal;
a phase of the received reference signal;
a doppler shift at one or more antenna ports;
a channel state information (CSI), including a change or a pattern of changes of one or more of a channel quality indicator (CQI), a rank indicator (RI), CSI-RS resource indicator (CRI), SS/PBCH resource block indicator (SSBRI), Layer Indicator (LI) or a precoder matrix indicator (PMI).

35. The apparatus of claim 30, wherein the controlling transmitting, by the user node to the network node, information indicating that there is a predicted decrease in radio network performance comprises causing the apparatus to control transmitting at least one of the following:
information indicating at least one radio network performance parameter; and/or
information indicating a predicted value or a predicted level of change for the at least one radio network performance parameter for the radio link between the user node and the network node.

36. The apparatus of claim 30:
further comprising causing the apparatus to control receiving, by the user node, a signal including at least one reflection of the sidelink signal that has been at least partially passively reflected from at least one object within the physical environment;
wherein the determining channel information comprises determining or measuring, by the user node, channel information for the sidelink channel, based on the received signal.

37. The apparatus of claim 30:
wherein the controlling transmitting the sidelink signal further comprises controlling transmitting, by the user node, a Frequency-Modulated Continuous Wave radar signal using the sidelink resources of the sidelink channel;
further comprising causing the apparatus to control receiving, by the user node, a signal including at least one reflection of the Frequency-Modulated Continuous Wave radar signal that has been at least partially passively reflected from at least one object within the physical environment;
wherein the determining channel information further comprises determining or measuring, by the user node, channel information for the sidelink channel, based on the received signal.
